(19) United States
(12) Patent Application Publication
(10) Pub. No.: US 2018/0284441 A1
(43) Pub. Date: Oct. 4, 2018

(54) WIDE FIELD HEAD MOUNTED DISPLAY

(71) Applicant: Corning Incorporated, Corning, NY (US)

(72) Inventor: Joshua Monroe Cobb, Victor, NY (US)

(73) Assignee: Corning Incorporated, Corning, NY (US)

(21) Appl. No.: 15/765,793

(22) PCT Filed: Oct. 5, 2016
(86) PCT No.: PCT/US2016/055442

§ 371 Date: Apr. 4, 2018

Related U.S. Application Data
(60) Provisional application No. 62/238,976, filed on Oct. 8, 2015.

(51) Int. Cl. G02B 27/01; G02B 3/08; G02B 5/02

(52) U.S. Cl. CPC G02B 27/0172; G02B 3/08; G02B 2027/011; G02B 2027/0174; G02B 5/0215

(57) ABSTRACT

An optical apparatus for display to a viewer has a concave spherical mirror that has a center of curvature at the viewer's pupil and that has a second radius of curvature. An image generation apparatus forms an image onto a spherical diffusive surface, wherein the spherical diffusive surface has a first radius of curvature that is substantially half the length of the second radius of curvature. A beam splitter is positioned along a principal axis of the concave spherical mirror and optically disposes the curved diffusive surface at the focal surface of the concave spherical mirror.

This application claims the benefit of priority under 35 U.S.C. § 119 of U.S. Provisional Application Ser. No. 62/238,976 filed on Oct. 8, 2015, the content of which is relied upon and incorporated herein by reference in its entirety.

### FIELD OF THE INVENTION

The disclosure relates generally to wearable display devices and more particularly to apparatus and methods for a wide-field head-mounted display having a monocentric pupil imaging system.

### BACKGROUND

Wearable display devices make it possible to provide image content to a viewer in applications where the use of conventional display screens would be an encumbrance. Head-mounted devices (HMDs), such as display goggles, are being considered and used in a variety of fields, with applications ranging from military, medical, dental, industrial, and gaming fields, among others. Stereoscopic imaging, with its enhanced spatial representation and improved presentation of relevant detail, can be particularly useful for presenting images that are more lifelike and that show depth information more accurately than can be possible with 2-dimensional (2-D) flat displays.

Although a number of advances have been made for improving usability, size, cost, and performance of wearable display devices, there remains considerable room for improvement. In particular, imaging optics that present the electronically processed images to the viewer have been disappointing. Conventional design approaches have proved difficult to scale to the demanding size, weight, and placement requirements, often poorly addressing problems related to field of view and distortion, eye relief, pupil size, and other factors.

There is a need for wearable display solutions that allow increased field of view, reduced image aberration, sufficiently large pupil size, and good overall performance at low cost, providing HMDs that are readily manufacturable and inherently adapted to the human visual system.

### SUMMARY OF THE INVENTION

According to one embodiment disclosed herein of the present disclosure, there is provided an optical apparatus for display to a viewer comprises:

a concave spherical mirror that has a center of curvature at the viewer's pupil and that has a second radius of curvature;

an image generation apparatus that forms an image onto a spherical diffusive surface, wherein the spherical diffusive surface has a first radius of curvature that is substantially half the length of the second radius of curvature; and

a beam splitter that is positioned along a principal axis of the concave spherical mirror and that optically disposes the curved diffusive surface at the focal surface of the concave spherical mirror.

According to an alternate embodiment of the present disclosure, there is provided a head-mounted optical apparatus for display to a viewer comprising:
a) a light source that directs modulated light along an optical axis;
b) a scanning apparatus that comprises:
   (i) a focusing lens that defines a focal point along the optical axis;
   (ii) a scanning mirror that is actuable to fold the optical axis and redirect the focal point for scanned light onto a spherically curved diffusive surface;
   (iii) wherein the spherically curved diffusive surface has its center of curvature at the scanning mirror and has a first radius of curvature;
c) a concave spherical mirror that has its center of curvature near the viewer's pupil and that has a second radius of curvature that is substantially twice the length of the first radius of curvature; and
d) a beam splitter that is disposed to redirect scanned light from the diffusive surface toward the concave spherical mirror, and that is disposed to provide an optically conjugate relation between the viewer's pupil and the scanning mirror.

Additional features and advantages will be set forth in the detailed description which follows, and in part will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

FIG. 1 is a schematic side view that shows optical characteristics and relationships related to a spherical mirror.

FIG. 2 is a schematic side view diagram that uses a spherical curved mirror for imaging in a head mounted optical apparatus according to an embodiment of the present disclosure.

FIG. 3 is a perspective view that shows a head-mounted optical apparatus for stereoscopic viewing.

FIG. 4 is a perspective view from the side that shows components for left eye imaging, as an example, and shows some exemplary light rays.

FIG. 5 is a schematic view that shows an alternate embodiment of the head-mounted optical apparatus, again using left eye imaging as an example.

FIG. 6A is a schematic diagram that shows, from a front view perspective, a head-mounted optical apparatus with exemplary rays for right eye imaging in an augmented reality configuration.

FIG. 6B is a schematic diagram that shows, from a front view perspective, a head-mounted optical apparatus configured for virtual reality viewing with an optional augmented reality configuration.

FIG. 7A is a schematic diagram that shows an image generation apparatus using a projector that uses a spatial light modulator.

FIG. 7B is a schematic diagram that shows forming a tiled image using a spatial light modulator.

FIG. 8 is a schematic diagram that shows an image generation apparatus using a projector that uses a spatial light modulator in an alternate embodiment.

FIG. 9A is a schematic side view that shows a display apparatus that uses an image formed on an emissive display surface.

FIG. 9B is a schematic perspective view of a display apparatus that uses an image formed on an emissive display surface.

### DETAILED DESCRIPTION

Figures shown and described herein are provided in order to illustrate key principles of operation and fabrication for an optical apparatus according to various embodiments and a number of these figures are not drawn with intent to show actual size or scale. Some exaggeration may be necessary in order to emphasize basic structural relationships or principles of operation.

The figures provided may not show various supporting components, including optical mounts, power sources, image data sources, and circuit board mounting for standard features used in a display device. It can be appreciated by those skilled in the optical arts that embodiments of the present invention can use any of a number of types of standard mounts and support components.

In the context of the present disclosure, terms such as “top” and “bottom” or “above” and “below” or “beneath” are relative and do not indicate any necessary orientation of a component or surface, but are used simply to refer to and distinguish views, opposite surfaces, spatial relationships, or different light paths within a component or apparatus. Similarly, terms “horizontal” and “vertical” may be used relative to the figures, to describe the relative orthogonal relationship of components or light in different planes relative to standard viewing conditions, for example, but do not indicate any required orientation of components with respect to true horizontal and vertical orientation.

Where they are used, the terms “first”, “second”, “third”, and so on, do not necessarily denote any ordinal or priority relation, but are used for more clearly distinguishing one element or time interval from another. These descriptors are used to clearly distinguish one element from another similar element in the context of the present disclosure and claims.

The terms “viewer”, “observer”, and “user” can be used interchangeably in the context of the present disclosure to indicate the person wearing a wearable optical apparatus.

As used herein, the term “energizable” relates to a device or set of components that perform an indicated function upon receiving power and, optionally, upon receiving one or more enabling signals. For example, a laser diode is energizable to emit a beam of laser light and can be modulated for image presentation according to image data signals.

In the context of the present disclosure, two planes, direction vectors, or other geometric features are considered to be substantially orthogonal when their actual or projected angle of intersection is within +/−2 degrees of 90 degrees.

In the context of the present disclosure, the term “oblique” or phrase “oblique angle” is used to mean a non-normal angle that is slanted so that it differs from normal, that is, differs from 90 degrees or from an integer multiple of 90 degrees, by at least about 2 degrees or more along at least one axis. For example, an oblique angle may be at least about 2 degrees greater than or less than 90 degrees using this general definition.

In the context of the present disclosure, the term “coupled” is intended to indicate a mechanical association, connection, relation, or linking, between two or more components, such that the disposition of one component affects the spatial disposition of a component to which it is coupled. For mechanical coupling, two components need not be in direct contact, but can be linked through one or more intermediary components.

In the context of the present disclosure, the term “left eye image” describes a virtual image that is formed in the left eye of the viewer and a “right eye image” describes a corresponding virtual image that is formed in the right eye of the viewer. The phrases “left eye” and “right eye” may be used as adjectives to distinguish imaging components for forming each image of a stereoscopic image pair, as the concept is widely understood by those skilled in the stereoscopic imaging arts.

The term “at least one of” is used to mean one or more of the listed items can be selected. The term “about” or “approximately”, when used with reference to a dimensional measurement or position, means within expected tolerances for measurement error and inaccuracy that are accepted in practice. The expressed value listed can be somewhat altered from the nominal value, as long as the deviation from the nominal value does not result in failure of the process or structure to conform to requirements for the illustrated embodiment.

With relation to dimensions, the term “substantially” means within better than +/−12% of a geometrically exact dimension. Thus, for example, a first dimensional value is substantially half of a second value if it is in the range of from about 44% to about 56% of the second value. Positions in space are “near” each other or in close proximity when, relative to an appropriate reference dimension such as a radius of curvature, a focal point, a component location, or other point on an optical axis, distance dimensions are substantially the same, no more than about 12% apart, preferably within 5% or 1% or less distance from each other.

The term “actuable” has its conventional meaning, relating to a device or component that is capable of effecting an action in response to a stimulus, such as in response to an electrical signal, for example.

The term “in signal communication” as used in the application means that two or more devices and/or components are capable of communicating with each other via signals that travel over some type of signal path. Signal communication may be wired or wireless. The signals may be communication, power, data, or energy signals which may communicate information, power, and/or energy from a first device and/or component to a second device and/or component along a signal path between the first device and/or component and second device and/or component. The signal paths may include physical, electrical, magnetic, electromagnetic, optical, wired, and/or wireless connections between the first device and/or component and second device and/or component. The signal paths may also include additional devices and/or components between the first device and/or component and second device and/or component.

The term “exemplary” indicates that the description is used as an example, rather than implying that it is an ideal.

Monocentric design offers a number of advantages and helps to reduce image aberrations. However, monocentric design can be difficult to adapt to optical systems in which space is at a premium. In general, monocentric systems allow the same performance in all fields of view, allowing expansion to larger fields when compared against non-monocentric systems.

With respect to positions of components or centers of curvature or other features of an optical apparatus, the term “near” has its standard connotation as would be used by one skilled in the optical design arts, with consideration for expected manufacturing tolerances and for measurement inaccuracies, for example, as well as for expected differences between theoretical and actual behavior of light.

In the context of the present disclosure, the use of the phrase “to optically dispose” is consistent with its use among those skilled in the optical design arts. This phrase indicates an optical equivalence that is based on either transmission or reflection by a beam splitter surface. With respect to a reference component, a second component is optically disposed at a particular position when the light handling behavior of the second component appears to be equivalent to its behavior if it were actually placed at that particular position.

As is well known, the light distribution within and from a specific optical system depends on its overall configuration, which need not be geometrically perfect or exhibit ideal symmetry for suitable performance. For example, a perfect rotationally symmetrical spherical reflector would ideally direct collimated light parallel to the optical axis through its vertex to a “focal point”. However, as is familiar to those skilled in optical fabrication, only a reasonable approximation to such idealized geometric shapes can be realized in practice and a perfect focal point is not needed for reduced-aberration imaging. The light distribution for a spherical mirror is more accurately described as focused on a small region that is substantially centered about a focal point; however, for the purposes of description, the conventional terms such as “focal point” and “center of curvature” are used, as would be familiar to those skilled in optics design.

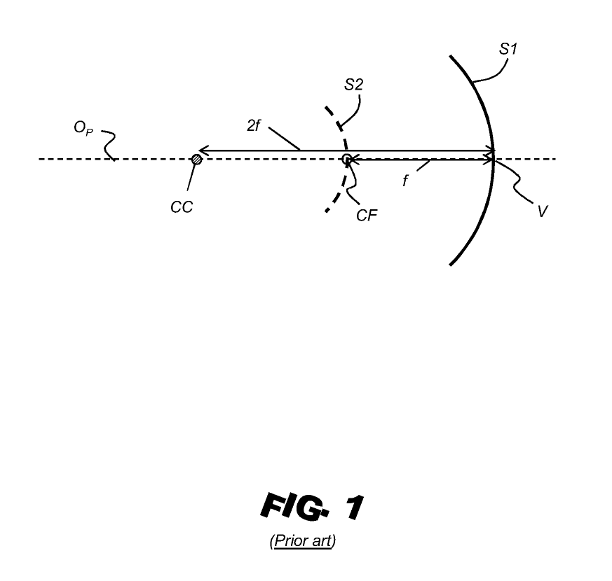

It is useful to review some optical concepts that relate to an optical system that uses a spherical mirror. Referring to the schematic diagram of FIG. 1, there is shown, in side view representation, a spherical mirror S1 having a center of curvature CC that lies along a principal axis O_{P}. Halfway between center of curvature CC and a vertex V of mirror S1, at the intersection of principal axis O_{P} and the mirror S1 surface, is a focal point CF at the center of focus. Point CF is a distance f from the mirror S1 vertex V; center of curvature CC is then a distance 2f from vertex V. Light emanating toward mirror S1 through focal point CF is collimated as reflected by mirror S1. Surface S2, shown as a dashed arc which includes focal point CF along principal axis O_{P}, when concentric with respect to the mirror S1 surface, forms a curved focal surface with respect to mirror S1. Within the angular range of mirror S1, light emanating from focal surface S2 or light intersecting points on focal surface S2 exhibit similar behavior to light at focal point CF. Thus, light emanating from spherically curved focal surface S2 is substantially collimated by spherical mirror S1.

Embodiments of the present disclosure employ aspects of spherical mirror light handling to help provide a head-mounted display apparatus that exhibits reduced aberrations and improved image quality over alternative designs.

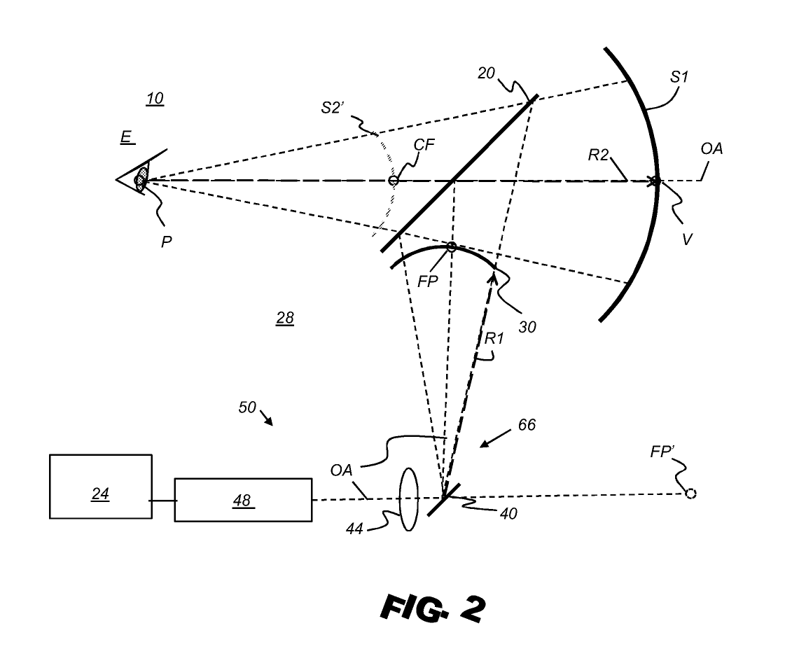

The schematic cross-section diagram of FIG. 2 shows an embodiment of an image-forming apparatus 28 of the present disclosure that uses a spherical curved mirror S1 for imaging in a head mounted optical apparatus 10. Components for generating an image for a single eye E are shown for clarity; for a stereoscopic head-mounted apparatus 10, the basic components shown in FIG. 2 are duplicated, so that there is a similar image-forming apparatus 28 for the other eye. Mirror S1 has its center of curvature at or near a pupil P of eye E of the viewer. A beam splitter 20 is interposed between eye E and mirror S1, substantially centered on an optical axis OA, so that it optically disposes a curved diffusive surface 30 at the focal surface of mirror S1.

In FIG. 2, the optically equivalent position of the focal surface provided by diffusive surface 30, through the beam splitter 20, is shown as surface S2′. An image generation apparatus 50, such as a scanning apparatus 66 using a laser projector 48 and scanning components, generates an image having one or more image pixels and projects and focuses the light that forms this image onto diffusive surface 30. In the embodiment shown in FIG. 2, scanning apparatus 66 has a scanning mirror 40 and a lens 44 for focusing the generated image onto diffusive surface 30. An optional control logic processor 24 is in signal communication with laser projector 48. Control logic processor 24 can be a dedicated microprocessor or a connected computer or other signal generating device that can be energized to provide image content and control signals for laser projector 48. Control logic processor 24 also has a connection to scanning mirror 40 for coordinating the modulation of the laser light beam with corresponding angles of scanning mirror 40; this connection is not shown explicitly in FIG. 2.

The rate at which scanning mirror 40 traverses the modulated light beam across curved diffusive surface 30 and the rate at which the light beam is modulated prior to scanning both determine the image resolution that can be obtained. The scanning speed is a factor in determining the number of pixels that can be displayed over a given area of the image. An embodiment of the present disclosure takes advantage of the capability to change the scanning mirror 40 speed over its scan, increasing the density of image pixels over central portions of the projected image so that the viewer perceives a higher-resolution image. Pixel density, over the extent of the image that is formed by apparatus 10, can be varied by some amount, so that, for one given portion of the image, pixel density is higher than over other areas, such as by having 5% or 10% more pixels per inch, for example.

Changing pixel density can be effective for improved imaging, such as by increasing pixel density over central portions of the field of view. The human eye itself has better resolution with vision in the foveal region, decreasing in perception of resolution at angles that move toward edges of the visual field. Thus, slowing the scan slightly over central regions of the image on diffusive surface 30, or increasing the light modulation rate over that portion of the scan cycle, or changing both scan rate and modulation rate, can allow changes in pixel density over different regions of the virtual image that is formed by head-mounted apparatus 10.

A number of geometric and optical relationships that support monocentric imaging are shown in the FIG. 2 embodiment of head-mounted optical apparatus 10. Diffusive surface 30 has its center of curvature at scanning mirror 40. The radius of curvature of diffusive surface 30, shown as radius R1, is half of the radius of curvature of spherical mirror S1, shown as radius R2 and extending between vertex V and pupil P. Through beam splitter 20 and mirror S1, pupil P is optically conjugate to scanning mirror 40.

Lens 44 defines a focal point FP along an optical axis OA, shown to the right of lens 44 in the FIG. 2 configuration. Before the light reaches the undeviated focal point of lens 44 that lies along the axis of rotational symmetry of lens 44, represented as FP′ in FIG. 2, scanning mirror 40 folds optical axis OA and redirects the focal point (focal region) onto convex spherically curved diffusive surface 30. According to an embodiment of the present disclosure, scanning mirror 40 is the reflective scanning component of a microelectromechanical systems (MEMS) device. MEMS devices include a number of mechanical components that provide systems of miniaturized mechanical and electromechanical elements (that is, devices and structures) that are made using microfabrication techniques analogous to those used for forming semiconductor devices. MEMS devices can vary from relatively simple structures having no moving elements, to extremely complex electromechanical systems with multiple moving elements under the control of integrated microelectronics. In a MEMS device, at least some of the elements have a mechanical function, whether or not the elements are themselves movable. MEMS devices are alternately termed “micro-machined devices” or devices formed and operating using microsystems technologies. Physical dimensions of individual moving MEMS elements can range from well below one micron to several millimeters. In the context of the present disclosure, MEMS devices provide mechanically movable elements, such as reflectors, that are energizable to temporally and spatially modulate the laser light beam in order to provide a two-dimensional image using a raster scan pattern.

The beam splitter 20 is disposed to redirect scanned light from the diffusive surface 30 toward the concave spherical mirror S1, and is disposed to provide an optically conjugate relation between the viewer's pupil P and the scanning mirror 40.

Still with reference to FIG. 2, because diffusive surface 30 has its center of curvature at the scanning mirror 40, and because the focal point of lens 44 is at distance R1 from mirror 40, the scanned image that is formed is in focus along the curved diffusive surface 30. Curved spherical mirror S1 can then form an image for the viewer's eye E having a spherical wavefront that is relatively aberration-free. The use of diffusive surface 30 provides a spherical intermediate image that effectively increases the numerical aperture (NA) and the etendue of the image-bearing light to effect a large exit pupil (or larger eye-box) at the pupil P of the viewer. Without diffusion of the low-NA incident light from diffusive surface 30, only a tiny pupil could be formed; the resulting pupil in such a case would simply have the size of the MEMS scanning mirror 40. Lens 44 can be a simple spherical lens of straightforward design, since it is used to focus light over a small field using low NA optics. Some brightness is compromised; however, the optics of FIG. 2 are used to form a system of reduced size. Lens 44, located along the light path before expansion of the NA by the diffusive surface, can be a simple lens for handling light at low NA and with a small field.

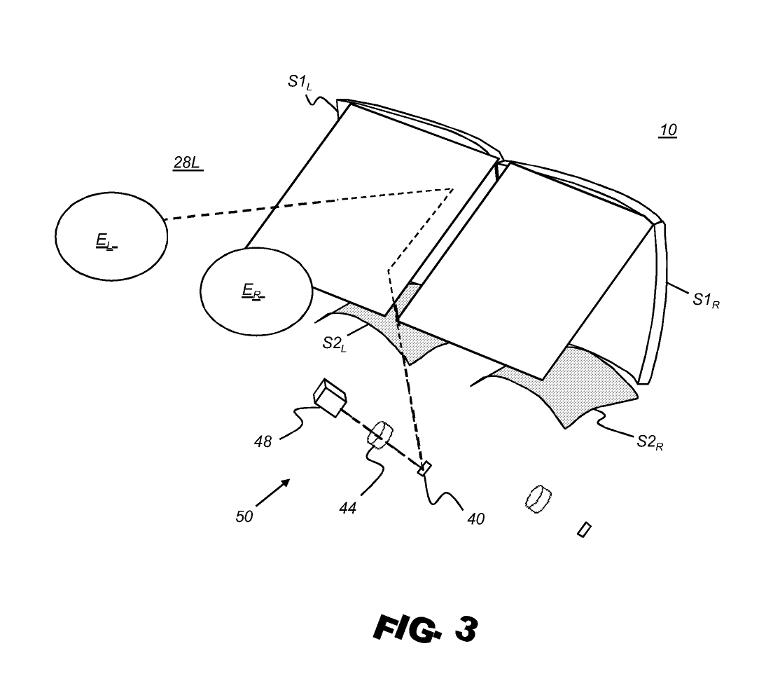

As noted previously, a stereoscopic embodiment of head-mounted optical apparatus can have the image-forming apparatus 28 components of FIG. 2 for each eye of the viewer. The perspective view of FIG. 3 shows a head-mounted optical apparatus 10 for stereoscopic viewing. Components of an image generation apparatus 50 are labeled, and the optical path traced, for the image-forming apparatus 28L for the left eye E_{L} in FIG. 3; duplicate components and a corresponding optical path are used for right eye E_{R}. The image-bearing light from laser projector 48 or other image source is focused by lens 44 onto convex spherically curved diffusive surface S2L. Beam splitter 20 directs this light to spherical mirror S1_{L} that forms an image for eye E_{L}. Curved diffusive surface S2_{R} and spherical mirror S1_{R} operate similarly to form the image for right eye E_{R}.

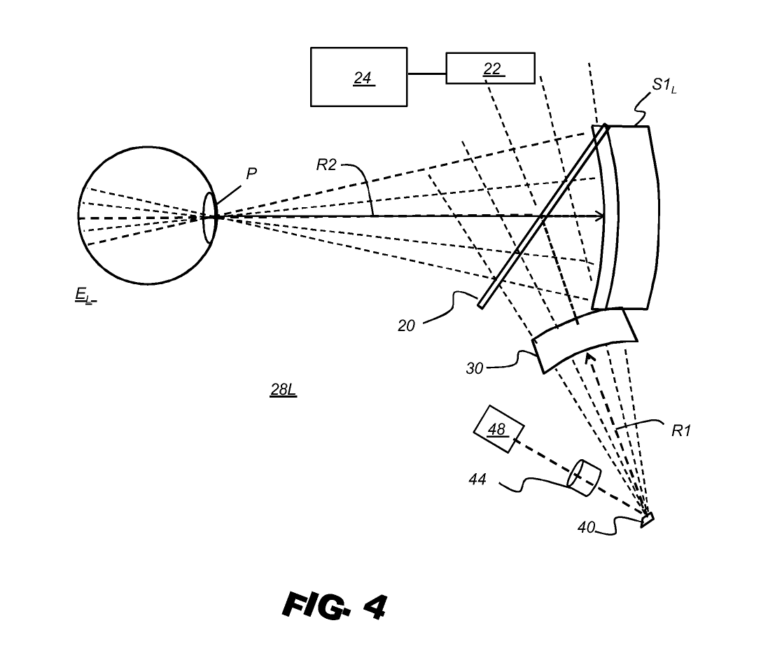

FIG. 4 is a perspective view from the side that shows components for image forming apparatus 28L for left eye E_{L} imaging and shows some exemplary light rays. As this figure shows, pupil P can be considerably enlarged, to provide an expanded viewing eye box. By way of example, according to an embodiment of the present disclosure, the FOV can be as large as 45 degrees (horizontal)×25 degrees (vertical). A radius R1 for the convex diffusive surface 30 can be 40 mm. Radius R2 for the spherical mirror can be 80 mm. The focal length of lens 44 can be 50 mm. It can be appreciated that components having other curvatures and focal lengths can alternately be used.

FIG. 4 also shows an optional camera 22 that can be used for gaze tracking, such as detecting the position of the viewer's eye E_{L} and pupil P and determining how to modify image presentation to accommodate a change in the viewer's attention. Camera 22 can observe the position of the eye through beam splitter 20 as shown. Camera 22 is also in signal communication with control logic processor 24.

In the context of the present disclosure, beam splitter 20 can be “partially transparent” or “substantially transparent.” A partially transparent beam splitter device transmits less than 50% of incident visible light and reflects the balance, redirecting more than 50% of incident light. A substantially transparent beam splitter device transmits more than 50% of incident visible light and reflects the balance, less than 50%.

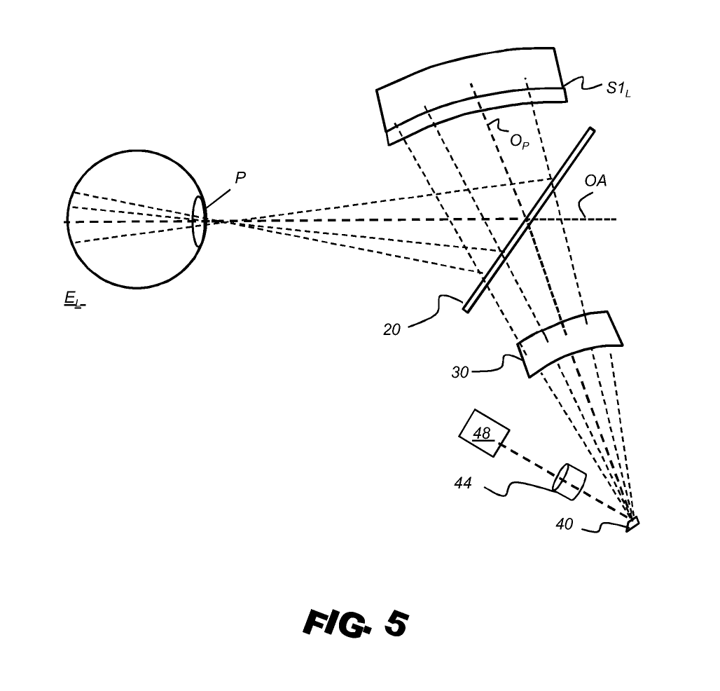

The schematic view of FIG. 5 shows an alternate embodiment of head-mounted optical apparatus 10 with beam splitter 20 as substantially transparent, according to the definitions used in the present disclosure. FIG. 5 again uses left eye E_{L} imaging as an example. Here, the position of spherical mirror S1_{L} is changed so that it reflects light that has been transmitted through beam splitter 20, rather than reflecting light that has been reflected from beam splitter 20 as shown, for example, in FIGS. 2-4. With this configuration, augmented reality imaging is now possible, since the viewer can see the real-world scene beyond partially transparent beam splitter 20, such as along optical axis OA, as well as images generated from laser projector 48 and reflected from curved mirror S1_{L}.

In the FIG. 5 arrangement, beam splitter 20 is positioned along a principal axis O_{P} of the concave spherical mirror S1_{L} and, through transmission, optically disposes the curved diffusive surface 30 at a focal surface of the concave spherical mirror S1_{L}, and is further disposed to provide an optically conjugate relation between the viewer's pupil and the scanning mirror 40.

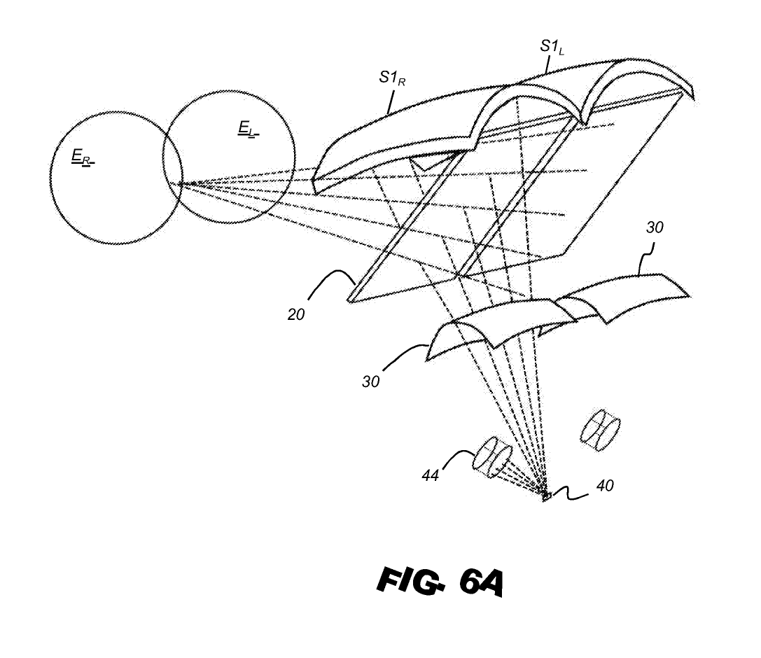

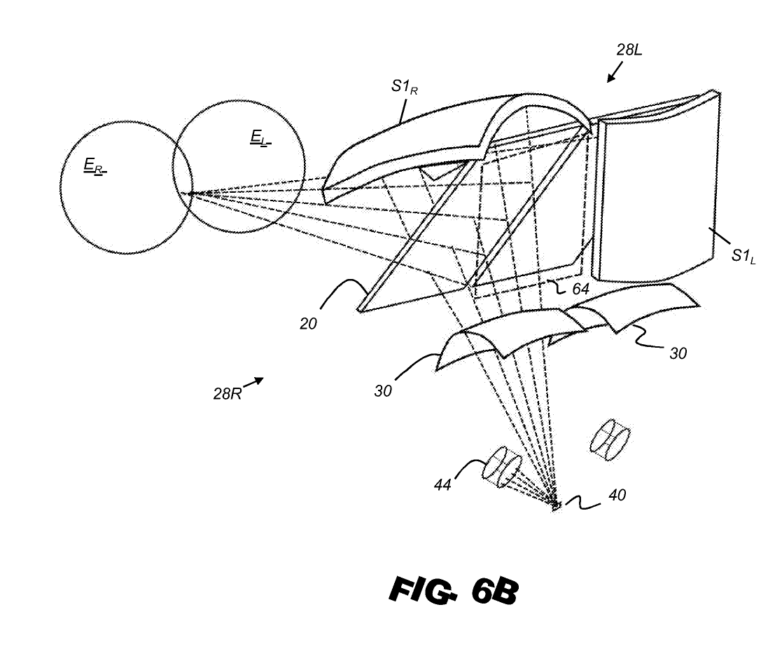

The schematic diagram of FIG. 6A shows, from a front view perspective, head-mounted optical apparatus 10 with exemplary rays for forming an image for right eye E_{R} in an augmented reality configuration. Again, components and light path for left eye E_{L} imaging would be duplicated.

According to still another alternate embodiment of the present disclosure, the virtual reality configuration of FIGS. 2-4 can be combined with the augmented reality configuration of FIGS. 5 and 6A to provide a hybrid virtual reality imaging system that uses the curved mirror arrangement of FIG. 4 for one eye and the reflected arrangement of FIG. 5 for the other eye. The schematic diagram of FIG. 6B shows an alternate embodiment of the present disclosure with left and right image-forming apparatus 28L and 28R, respectively, that provide virtual reality imaging with a widened field of view. Curved mirror S1R is positioned to reflect light to the eye, reflected through beam splitter 20 as shown in FIG. 5; curved mirror S1L is positioned to reflect light to the eye, transmitted through beam splitter 20, as shown in FIG. 4.

By comparison, the FIG. 6A configuration shows curved mirrors S1R and S1L contingent with each other, so that making one mirror larger with respect to the horizontal axis would make the other mirror smaller. In the FIG. 6B arrangement, on the other hand, mirrors S1L and S1R would not obstruct each other, each of these mirrors can extend across the full width of the field, providing a sizable FOV. FIG. 6B also shows, in dashed line form, an optional blocking screen 64 that blocks ambient light that would otherwise be in the line of sight of the viewer. Alternately, blocking screen 64 can be removed. Removal of screen 64 can allow augmented reality viewing for one of the viewer's eyes (the right eye in the FIG. 6B example) and virtual reality imaging for the other eye.

It should also be noted that, for embodiments in which augmented reality is not desirable and only an electronically generated image is desired, light from the real world can alternately be blocked for one or both eyes, such as by a shield.

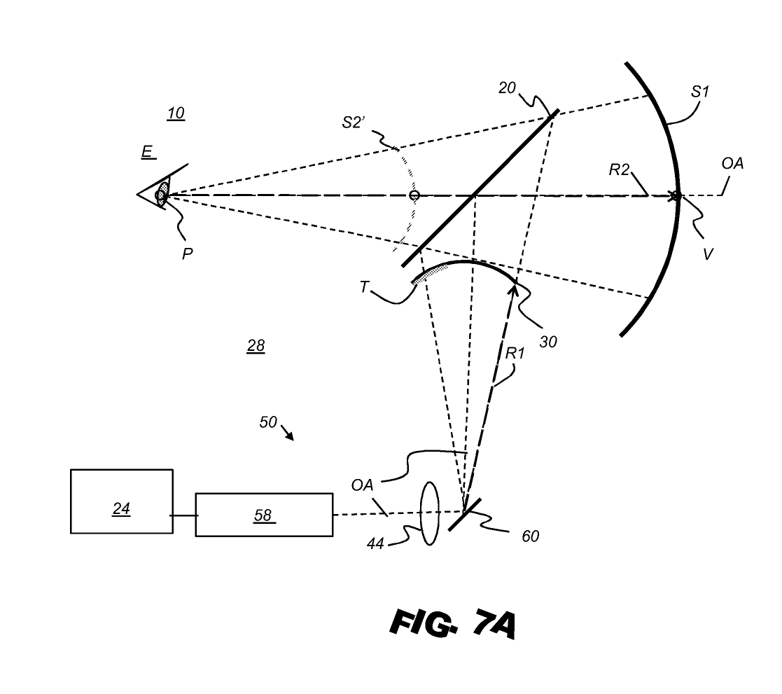

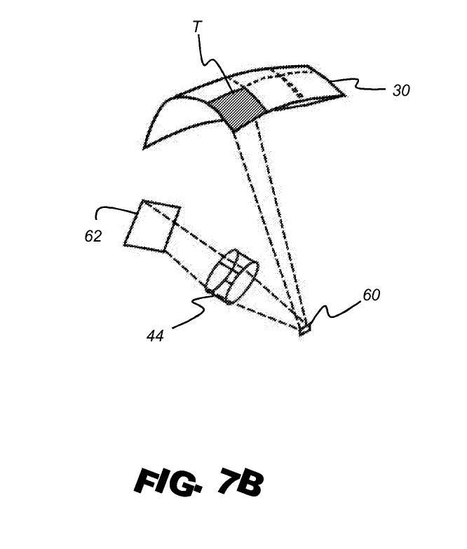

Other types of imaging sources that can be suitably adapted for generating an image formed on curved diffusive surface 30 include various types of spatial light modulators (SLM). The schematic diagram of FIG. 7A and perspective view of FIG. 7B show image generation apparatus 50 using a projector 58 that uses an SLM 62. Projector 58 directs the light to an actuable mirror 60 that successively scans a series of small 2-dimensional image segments or “tiles” T onto diffusive surface 30 to form an image for projection, providing a wide FOV and large viewing pupil. FIG. 7B shows actuable mirror 60 in a position for imaging one of the tiles T of a larger image. By rapidly forming and projecting individual 2-D tiles onto a spherical surface for forming the image, apparatus of the present disclosure can present a vivid set of images for stereoscopic imaging.

Various types of SLM devices can be used, including a Digital Light Processor (DLP) from Texas Instruments, Dallas, Tex.; a liquid crystal device (LCD), an organic light emitting diode (OLED), an LCOS (liquid crystal on silicon) device, or a grating electromechanical device, for example. A linear light modulator, scanned across the curved diffusive surface 30, could alternately be used.

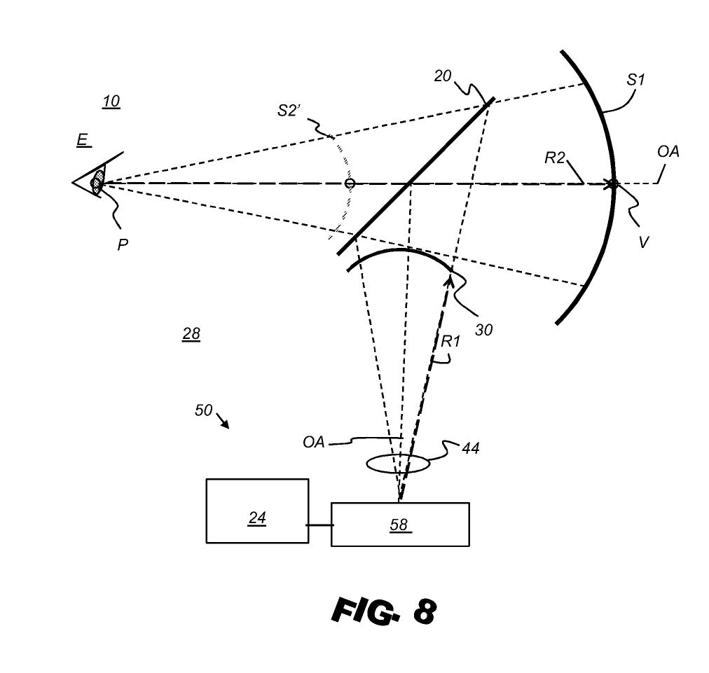

The schematic diagram of FIG. 8 shows an alternate embodiment using a projector 58 with an SLM and not requiring the use of a turning mirror or a scanner. Projector 58 directs light onto curved diffusive surface 30 through an optional lens 44.

Diffusive surface 30, used to increase the NA of the intermediate image that is formed, can be fabricated in a number of alternate ways. Diffusive surface 30 can be a fiber optic faceplate or a treated glass or plastic component, having a ground or chemically treated surface. Alternatively, holographic diffusive surfaces and curved diffusion films could be used. Holographic diffusive surfaces and diffusion films are available from a number of suppliers, such as Orafol Gmbh, Avon, Conn. and Physical Optics Corporation, Torrance, Calif. Spherical mirror S1 could be a holographic reflective element that provides the performance of a curved mirror but has the added advantage of flatness. Mirror S1 could alternately be a Fresnel reflective element, for example.

It should be noted that a holographic device or a Fresnel lens or mirror, although not exhibiting geometrical curvature, has an effective optical center of curvature that corresponds to its optical behavior as a reflective or refractive element. Thus, for example, a Fresnel mirror that exhibits equivalent light-redirecting capability and has the same focal surface as spherical mirror S1 has an effective optical center of curvature identical to that of mirror S1.

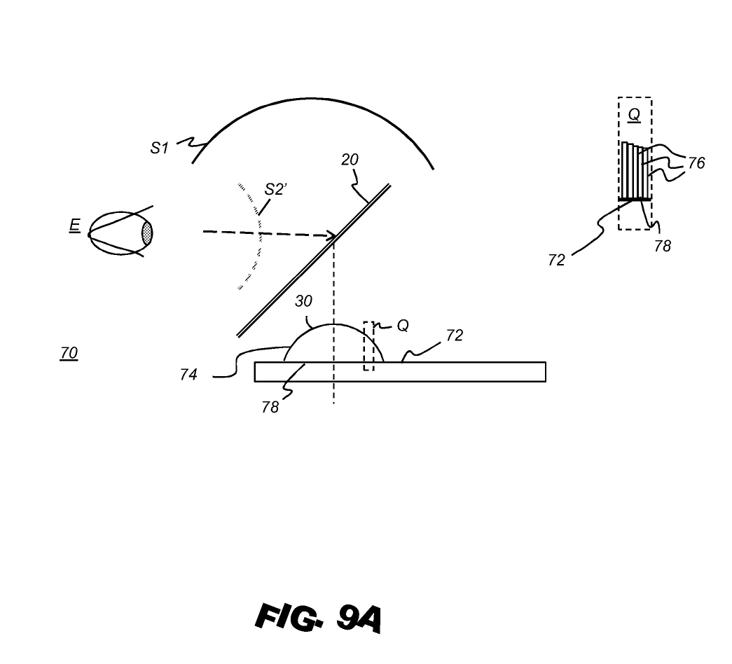

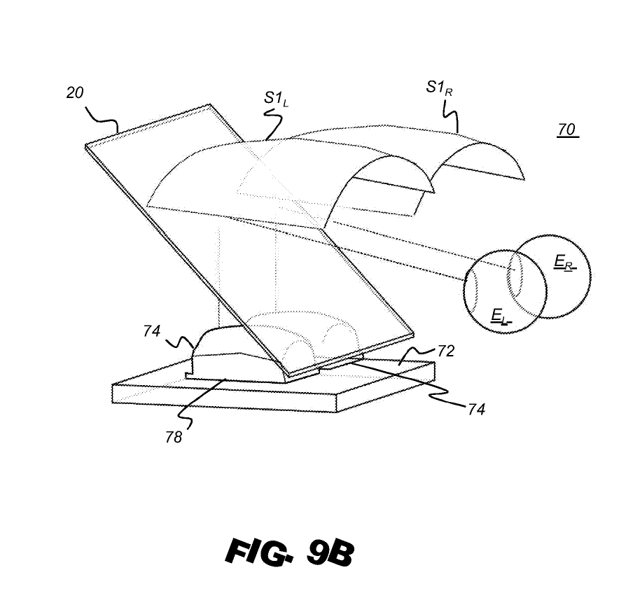

The intermediate image can alternately be generated by a display device that is configured to form an image on a diffusive surface. FIGS. 9A and 9B show schematic side and perspective views, respectively, of a display apparatus 70 that uses a source image generated from an emissive display surface 72, such as an image formed on an emissive organic light-emitting diode (OLED) display device or backlit liquid crystal display (LCD) device. For forming the image to each eye, a fiber optic faceplate 74 has a planar light entry surface 78 that seats against the flat emissive display surface 72 and conveys light that is emitted from the display to its curved convex diffusive surface 30. Beam splitter 20 and spherical mirrors S1, S1_{L}, S1_{R} perform the same functions described previously with respect to intermediate images formed by projection and scanning display devices. Curvature relationships and intermediate image placement follow the pattern described previously with reference to scanned light embodiments.

As is shown schematically in an enlarged area Q in FIG. 9A, fiber optic faceplate 74 is formed from hundreds or thousands of parallel optical fibers 76. Each fiber 76 extends from the planar light entry surface 78 to curved diffusive surface 30; fiber 76 width can be any suitable size and, in practice, is typically a fraction of the pixel size of display surface 72. Diffusion occurs as each fiber 76 increases the NA of light incident from its corresponding portion of display surface 72. As is shown schematically in FIG. 9B, there is a fiber optic faceplate 74 for forming the image for each eye. A single display surface 72 or separate display surfaces 72 can be used for providing the left- and right-eye image content.

Embodiments of the present disclosure can be incorporated into HMD or other types of wearable displays for monoscopic or stereoscopic augmented reality or virtual reality viewing. Alternately, one or more configurations of the display apparatus that are shown can have some other configuration for monoscopic or stereoscopic viewing, such as a hand-held configuration, for example.

According to another alternate embodiment of the present disclosure, a projection system is used to focus light for forming an image at the focal surface of spherical surface S1, but without requiring diffusive surface 30. This arrangement, however, would exhibit a small pupil size, limited by the NA (numerical aperture) of the MEMS scanning mirror.

A laser projector can include a color combiner that combines component beams of different colors, such as beams having red, green, and blue wavelengths. Alternately, the lasers can be remote from other head-mounted apparatus components, with the laser light directed through an optical fiber for providing image content to the optical system.

It must be noted, however, that the use of the term “monocentric” in optical design is, in practice, less rigid than the strict geometric definition of a monocentric system that requires perfectly concentric surfaces. In an optical system, for example, it is often not feasible or even desirable to design a system that is perfectly geometrically monocentric. In the instant case, for example, both of the viewer's eyes cannot be fixed in the exact position that would otherwise be required for a strictly geometric system. Some amount of tolerance must be allowed for movement of the eyes, even when within the viewer's eye box.

A monocentric optical system is generally characterized as having a relatively high degree of symmetry for its curved surfaces. Thus, the term “monocentric” indicates that the system design form has two or more of the curved surfaces of the system substantially concentric, with reasonable allowance for optical tolerances and scale and some adjustment for non-spherical surfaces used to generate and direct the image scene content. In the case of the head mounted optical apparatus 10 shown in FIG. 6A, the substantially concentric curved surfaces of spherical mirror S1R and its corresponding curved diffusive surface 30 have their respective centers of curvatures at or in close proximity to each other, such as within 2-4 mm or less, for example. This center of curvature lies at or near scanning mirror 40. The center of curvature may be along a folded path through a folding element, such as the beam splitter 20.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

It will be apparent to those skilled in the art that various modifications and variations can be made without departing from the spirit or scope of the invention. Since modifications combinations, sub-combinations and variations of the disclosed embodiments incorporating the spirit and substance of the invention may occur to persons skilled in the art, the invention should be construed to include everything within the scope of the appended claims and their equivalents.

1. An optical apparatus for display to a viewer comprising:
a concave spherical mirror that has a center of curvature at the viewer's pupil and that has a second radius of curvature;
an image generation apparatus that forms an image onto a spherical diffusive surface, wherein the spherical diffusive surface has a first radius of curvature that is substantially half the length of the second radius of curvature; and
a beam splitter that is positioned along a principal axis of the concave spherical mirror and that optically disposes the spherical diffusive surface at the focal surface of the concave spherical mirror.

2. The apparatus of claim 1 wherein the image generation apparatus comprises a laser light source, a scanning mirror, and a lens that focuses one or more image pixels onto the spherical diffusive surface.

3. The apparatus of claim 1 wherein the image generation apparatus comprises a spatial light modulator.

4. The apparatus of claim 1 wherein the image generation apparatus comprises a linear light modulator.

5. The apparatus of claim 2 wherein the beam splitter folds an optical axis in order to dispose the spherical diffusive surface at the focal surface of the spherical mirror.

6. The apparatus of claim 2 wherein the beam splitter transmits light from the spherical diffusive surface to the spherical mirror

7. The apparatus of claim 1 wherein the image generation apparatus projects one or more two-dimensional image tiles onto the spherical diffusive surface.

8. The apparatus of claim 1 wherein the concave spherical mirror comprises one or more holographic optical elements.

9. The apparatus of claim 1 wherein an image pixel density varies by more than 5% over the extent of the image.

10. A head-mounted optical apparatus for display to a viewer comprising:
a) a light source that directs modulated light along an optical axis;
b) a scanning apparatus that comprises:
(i) a focusing lens that defines a focal point along the optical axis;
(ii) a scanning mirror that is actuable to fold the optical axis and redirect the focal point for scanned light onto a spherically curved diffusive surface;
(iii) wherein the spherically curved diffusive surface has a first center of curvature at the scanning mirror and has a first radius of curvature;
c) a concave spherical mirror that has a second center of curvature near the viewer's pupil and that has a second radius of curvature that is substantially twice the length of the first radius of curvature; and
d) a beam splitter that is positioned along a principal axis of the concave spherical mirror and that optically disposes the curved diffusive surface at a focal surface of the concave spherical mirror, and that is further disposed to provide an optically conjugate relation between the viewer's pupil and the scanning mirror.

11. The apparatus of claim 10 wherein the curved diffusive surface comprises a fiber optic faceplate.

12. The apparatus of claim 10 wherein the beam splitter transmits more than half of the incident light received from the light source.

13. The apparatus of claim 10 wherein the curved diffusive surface is a treated glass component or a diffusion film.

14. The apparatus of claim 10 further comprising a camera that is disposed to detect the position of the viewer's pupil.

15. The apparatus of claim 10 wherein the concave spherical mirror is a holographic element or a Fresnel reflective element.

16. The apparatus of claim 10 wherein the light source comprises at least one laser.

17. The apparatus of claim 10 wherein the scanning mirror is a microelectromechanical systems device.

18. The apparatus of claim 10 wherein the light source, the scanning apparatus, the spherical mirror, and the beam splitter are duplicated for each eye of the viewer.

19. The apparatus of claim 10 wherein the beam splitter folds the principal axis of the concave spherical mirror.

20. A head-mounted display apparatus comprising a left image forming apparatus and a right image forming apparatus, respectively, for display to each left and right pupil of a viewer, each image forming apparatus comprising:
a) a laser light source that directs modulated laser light along an optical axis;
b) a scanning apparatus that comprises:
(i) a focusing lens that defines a focal point along the optical axis;
(ii) a scanning mirror that is actuable to fold the optical axis and scan the focal point across a spherically curved diffusive surface;
and
c) a beam splitter that is disposed to direct scanned light from the diffusive surface toward a concave spherical mirror,
wherein the spherical mirror has a first center of curvature at the corresponding pupil of the viewer,
wherein the curved diffusive surface is disposed along a focal surface of the spherical mirror and has a second center of curvature at the scanning mirror,
wherein, with respect to the spherical mirror, each corresponding pupil of the viewer is optically conjugate to the corresponding scanning mirror through the beam splitter.

21. A display apparatus comprising
a) a flat display surface that emits image-bearing light;
b) a left image forming apparatus and a right image forming apparatus for display to each left and right pupil of a viewer, respectively, each image forming apparatus comprising:
(i) a concave spherical mirror that has a center of curvature optically conjugate to the corresponding viewer's pupil and that has a second radius of curvature;
(ii) a fiber optic faceplate having a planar light entry surface that seats against the flat display surface and having a curved imaging surface, opposite the entry surface, that forms a spherically curved image field from the emitted image-bearing light,
wherein the curved imaging surface has a first radius of curvature that is substantially half the length of the second radius of curvature;
and
c) a beam splitter that is positioned along a principal axis of each concave spherical mirror and that optically disposes the corresponding curved imaging surface at the focal surface of the concave spherical mirror for the left and right image forming apparatus.

22. The display apparatus of claim 21 wherein the flat display surface is an organic light-emitting diode display.

23. The display apparatus of claim 21 wherein the flat display surface is a backlit liquid crystal display (LCD) device.
